(19) United States
(12) Patent Application Publication
(10) Pub. No.: US 2006/0244750 A1
(43) Pub. Date: Nov. 2, 2006

(54) Animation composing vending machine

(76) Inventor: Hyun Ok Kim, Jersey City, NJ (US)

Correspondence Address: JONES DAY, 222 EAST 41ST ST, NEW YORK, NY, 10017, US

(21) Appl. No.: 11/202,781

(22) Filed: Aug. 11, 2005

(30) Foreign Application Priority Data
May 2, 2005 (KR) 10-2005-0036741
May 2, 2005 (KR) 20-2005-0012278

(51) Int. Cl. G06T 15/70

(52) U.S. Cl. 345/473

(57) ABSTRACT

Disclosed is an animation composing vending machine capable of automatically composing a specific body part photographed from a user with animation contents. This machine processes a user face image captured by a camera into a face animation according to a predetermined program, automatically composes the processed face animation with a face-removed animation, and then stores and records the composed animation on a CD. Thus, there is no need of an operator to reduce a labor cost, and expensive 3D rendering software and high-performance computer may not be used. In addition, this machine may freely adopt various configuration of vending machines installed outdoors.

### BACKGROUND OF THE INVENTION

1. Field of the Invention

The present invention relates to an animation composing vending machine, and more particularly to an animation composing vending machine for automatically composing an image of a specific body part photographed from a user with animation contents.

2. Description of the Related Art

Generally, in order to compose an image obtained by photographing a specific body part by a common camera with animation, expensive 3-dimensional (hereinafter, referred to as “3D”) rendering software such as 3D Studio Max, Maya and so on and a high-performance computer capable of operating the 3D rendering software were required in each system, and also an operator who may directly manipulate the 3D rendering software was needed.

The expensive 3D rendering software is developed for common use. However, the work for composing a specific body part of a human with animation requires a very small part of functions of the software, which causes unnecessary increase of costs for the system. In addition, since the composing work is not automatically processed, an operator should handle the software, increasing a labor cost.

### SUMMARY OF THE INVENTION

The present invention is designed to solve the problems of the prior art, and therefore it is an object of the present invention to provide an animation composing vending machine capable of automatically composing a specific body part photographed from a user with animation contents.

In order to accomplish the above object, the present invention provides an animation composing vending machine, which includes a casing of a predetermined shape to stand on a ground; at least first and second monitors installed to an upper portion of the casing to be opposite to each other so that a user who makes a photograph and other persons are capable of watching images and texts displayed thereon at the same time; a camera installed in the casing at a position adjacent to the first monitor so as to capture an image of a user face; at least one speaker installed to an outer wall of the casing to output sounds in relation to animations; a peripheral device unit including a CD (Compact Disk) recorder installed in the casing to record a composed animation of the user face image captured by the camera on a CD, manipulation buttons installed to the casing for the user to manipulate for selection according to a request from the first monitor, and a cash verification unit installed in the casing to verify insertion of cash; a first controller installed in the casing in connection with the monitors, the camera, the speaker and the peripheral device unit, wherein the first controller instructs the first monitor to output a demo animation stored in a DB (database) unit together with messages for guiding insertion of cash, wherein, in case that cash is inserted into the cash verification unit, the first controller instructs the first monitor to output a plurality of sample animations stored in the DB unit and classified depending on theme and also guide the user to select the number of persons to be photographed, wherein, in case that a specific sample animation and the number of persons to be photographed are selected by means of the manipulation buttons, the first controller instructs the camera to capture an image of a user face, renders the captured user face image to conform to a corresponding face animation data of the sample animation stored in the DB unit and selected by the manipulation buttons according to a predetermined program to make a face animation, composes the face animation with a face-removed animation of the corresponding sample animation stored in the DB unit to make a composed animation, and then transmits the composed animation to the CD recorder to be recorded and stored in a CD; a second controller installed in the casing to be positioned between the first controller and the cash verification unit so as to control the cash verification unit; and a DB unit having a plurality of databases in the casing in connection with the first controller so as to store the user face image captured by the camera, to store face animation data classified depending on theme, to store face-removed animations classified depending on theme, and to store demo animations, various messages and sample animations classified depending on theme, which are to be displayed on the first monitor.

In the above configuration, the face animation data and the face-removed animation are preferably data respectively obtained by data processing of 3D animation.

In addition, the animation composing vending machine may further includes at least one lighting installed in the casing in connection to the second controller so as to irradiate light to the user photographed by the camera.

In addition, the animation composing vending machine may further include a printer installed in the casing in connection to the first controller so as to print a cover sheet to be adhered to the CD.

In addition, the animation composing vending machine may further include a light screen installed to the casing to be positioned in front of the first monitor.

In addition, the animation composing vending machine may further include an empty CD supplier installed in the casing in connection to the second controller so as to supply an empty CD.

The above objects and advantages and other features will become apparent from the following description with reference to the accompanying drawings.

### BRIEF DESCRIPTION OF THE DRAWINGS

Other objects and aspects of the present invention will become apparent from the following description of embodiments with reference to the accompanying drawing in which:

FIG. 1 is a perspective view showing an animation composing vending machine according to the present invention;

FIG. 2 is a perspective view showing a rear side of the animation composing vending machine according to the present invention;

FIG. 3 is a block diagram showing overall configuration of the animation composing vending machine according to the present invention;

FIG. 4 is a flowchart illustrating an operation method of the animation composing vending machine according to the present invention;

FIG. 5 is a block diagram showing the step of processing face-removed animation and face animation data previously stored in a database in the animation composing vending machine according to the present invention;

FIGS. 6 and 7 are schematic diagrams illustrating the step of composing a specific body image photographed from a user with animation contents in the animation composing vending machine according to the present invention.

### DESCRIPTION OF THE PREFERRED EMBODIMENT

Hereinafter, the present invention will be described in more detail referring to the drawings.

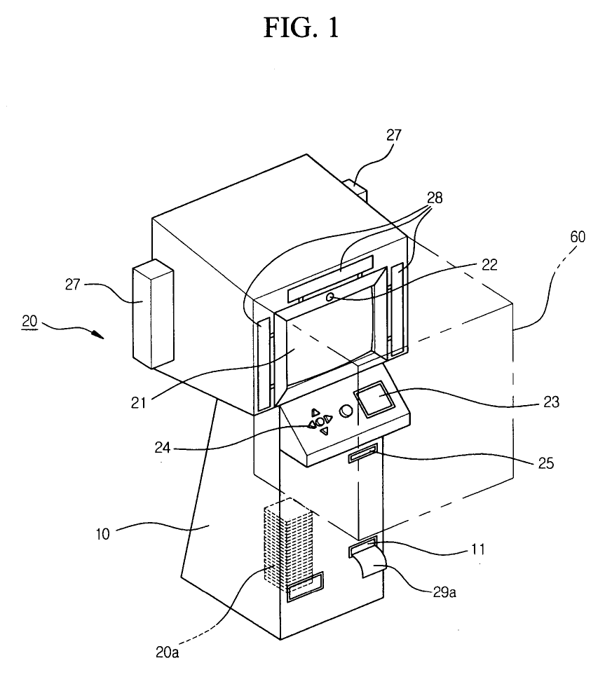

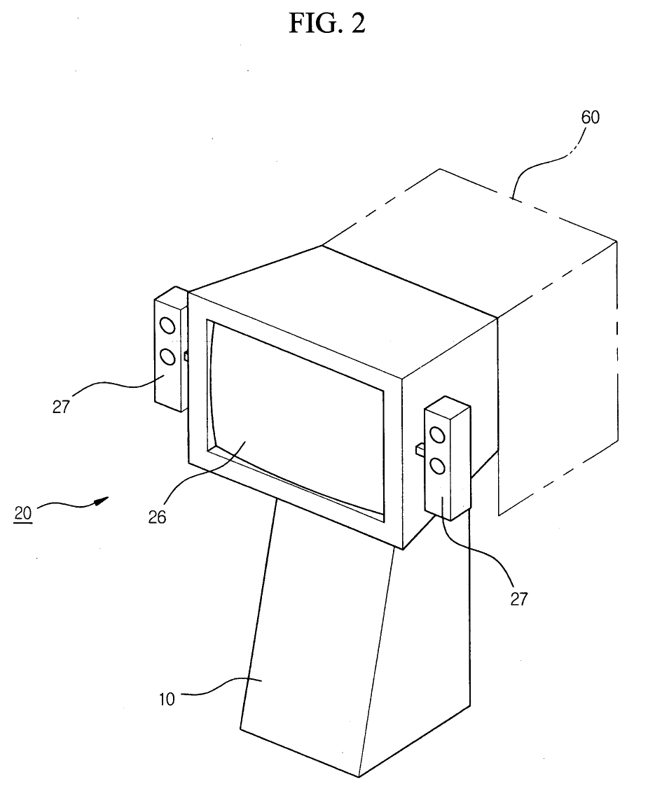

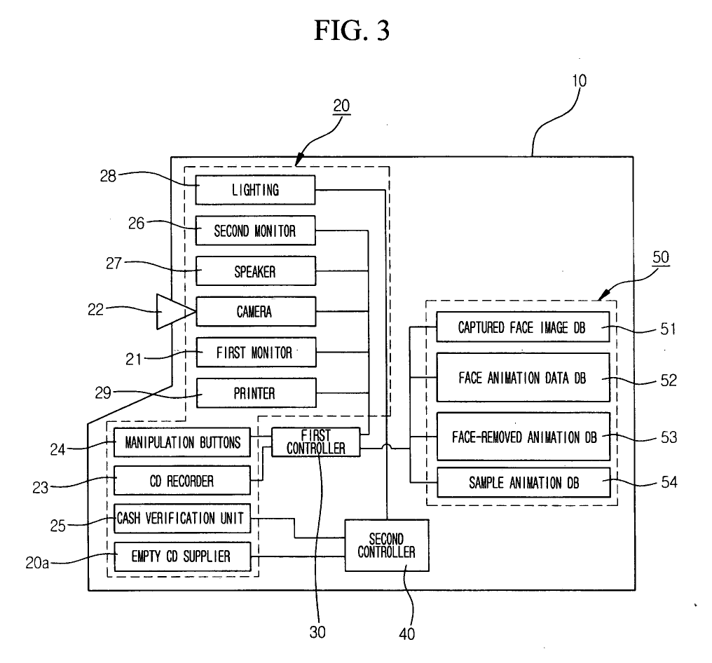

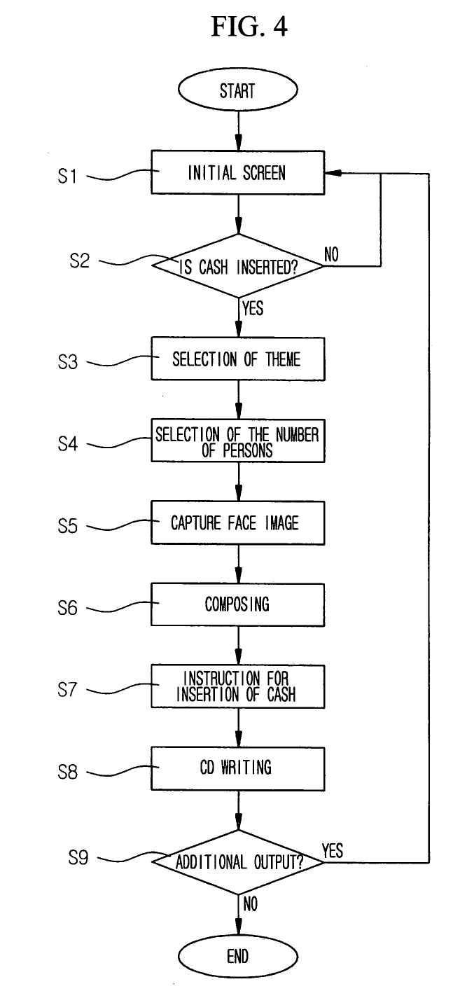

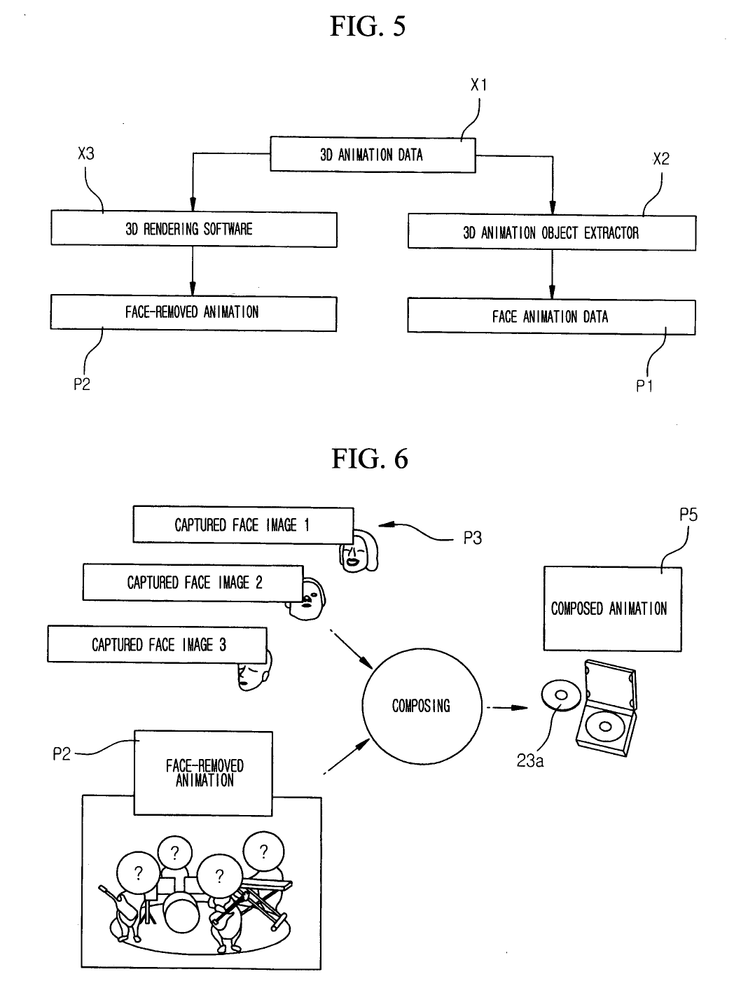

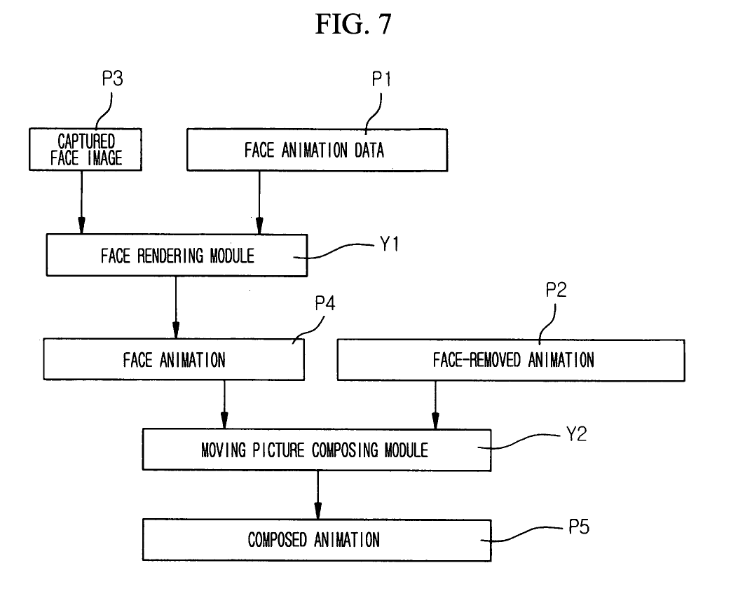

FIG. 1 is a perspective view showing an animation composing vending machine according to the present invention; FIG. 2 is a perspective view showing a rear side of the animation composing vending machine according to the present invention; FIG. 3 is a block diagram showing overall configuration of the animation composing vending machine according to the present invention; FIG. 4 is a flowchart illustrating an operation method of the animation composing vending machine according to the present invention; FIG. 5 is a block diagram showing the step of processing face-removed animation and face animation data previously stored in a database in the animation composing vending machine according to the present invention; and FIGS. 6 and 7 are schematic diagrams illustrating the step of composing a specific body part image photographed from a user with animation contents in the animation composing vending machine according to the present invention. As shown in the figures, the animation composing vending machine of the present invention includes a casing 10, a peripheral device unit 20, a first controller 30, a second controller 40 and a database unit (hereinafter, referred to as “DB unit”) 50, in brief.

The casing 10 has a predetermined shape to stand on a ground and gives a space for installing every components 20, 30, 40, 50.

The peripheral device unit 20 includes a first monitor 21 installed to an upper front side of the casing 10 to output various images and texts; a camera 22 installed in the casing 10 adjacent to the first monitor 21 to capture an image of a face part of a user; a CD recorder 23 installed in the casing 10 to record an animation, composing the user face part captured by the camera 22, in a compact disk (hereinafter, referred to as “CD”); manipulation buttons 24 installed to the casing 10 and having confirmation button and directional buttons to be selected by a user by guidance of messages displayed on the first monitor 21; and a cash verification unit 25 installed in the casing 10 to verify insertion of cash.

In addition, a second monitor 26 for outputting the same information as output by the first monitor 21 is preferably installed to an upper rear side of the casing 10, opposed to the first monitor 21. For this reason, persons other than a user standing in front of the first monitor 21 for photographing may share relevant information like a look or a pose of the user and animation contents selected by the user.

In addition, at least one speaker 27 is preferably installed to the casing 10 so as to output various sounds in relation to animations.

In addition, at least one lighting 28 for irradiating light to a user to be photographed by the camera 22 is preferably installed to the casing 10. The lighting 28 is installed to the casing 10 so as to irradiate light in the same direction as the camera 22.

In addition, a printer 29 is preferably installed in the casing 10 so as to print a cover sheet 29a to be adhered to a CD. The cover sheet 29a is discharged out through a discharge hole 11 formed in the casing 10.

In addition, an empty CD supplier 20a for supplying an empty CD is preferably installed in the casing 10. The empty CD supplier 20a contains empty CDs and then discharges any empty CD outward when required.

Here, the cash verification unit 25, the lighting 28 and the empty CD supplier 20a are connected to and controlled by the second controller 40. The second controller 40 is connected to the first controller 30 and controls operation of the cash verification unit 25, the lighting 28 and the empty CD supplier 20a. Other peripheral devices 21, 22, 23, 24, 26, 27 and 29 are connected to and controlled by the first controller 30.

Meanwhile, a light screen 60 is preferably installed to the casing 10 to be positioned in front of the first monitor 21. The light screen 60 prevents light emitted from the lighting 28 from being dispersed out so as to increase color temperature of the image captured by the camera 22. Thus, the light screen 60 is preferably installed to the casing 10 to surround the camera 22 and the lighting 28.

The first controller 30 instructs the first monitor 21 to output a demo animation and messages for guiding insertion of cash, previously stored in the DB unit 50.

In addition, if cash is inserted into the cash verification unit 25, the first controller 30 instructs the first monitor 21 to output a plurality of sample animations, previously stored in the DB unit 50 and classified depending on their theme, and also to guide the user to select the number of persons participating in photographing. The information related to whether cash is inserted into the cash verification unit 25 is transmitted to the first controller 30 via the second controller 40.

In addition, if a specific sample animation and the number of persons to be photographed are selected using the manipulation buttons 24, the first controller 30 instructs the camera 22 to capture an image of the face part of the user. The captured user face image P3 is rendered to conform to a corresponding face animation data P1 of a sample animation, stored in the DB unit 50 and selected by the manipulation buttons 24, according to a predetermined program so as to make a face animation P4. The face animation P4 is composed with a face-removed animation P2 previously stored in the DB unit 50, and then the composed animation P5 is transmitted to the CD recorder 23 and recorded and stored in a CD.

As shown in FIG. 5, the face animation data P1 and the face-removed animation P2 are respectively classified by data processing of a 3D animation data X1. The face animation data P1 is a data extracted from a data-processed 3D animation data X1 by 3D animation object extractor X2, and the face-removed animation P2 is a data generated by executing a 3D rendering software X3.

The first controller 30 may be a common personal computer, preferably using Window XP as a platform with specification of Intel Pentium IV CPU, RAM 512 MB or above, a graphic card of ATI Radeon 9000 or above supporting dual-monitor.

The DB unit 50 includes a DB 51 for storing a user face image P3 captured by the camera 22, a DB 52 for storing face animation data P1 classified depending on theme, a DB 53 for storing face-removed animations P2 classified depending on theme, and a DB 54 for storing demo animations, various messages and sample animations classified depending on theme, which are to be displayed on the first monitor 21.

Thus, as shown in FIG. 4, at ordinary times, the first and second monitors 21 and 26 initially output a demo animation in which a face part of human is composed with animation contents together with a message requesting insertion of cash. For this reason, the first controller 30 extracts the corresponding data from the sample animation DB 54 and then transmits it to the first and second monitors 21 and 26 (step S1). In addition, the number of remaining empty CDs may also be output on the initial screen of the first and second monitors 21 and 26.

In this state, if a user steps into the light screen 60 and inserts cash into the cash verification unit 25 as requested on the first and second monitors 21 and 26, the information is transmitted to the second controller 40, which outputs the same to the first controller 30 (step S2). After recognizing that cash is inserted, the first controller 30 extracts a plurality of sample animations, classified depending on theme, from the sample animation DB 54 and then transmits them to the first and second monitors 21 and 26 to be displayed out. The first and second monitors 21 and 26 output the plurality of sample animations classified depending on theme in a chessboard shape so that the user may see them at one glance. If the plurality of sample animations are output to the first and second monitors 21 and 26 as mentioned above, the user selects a desired sample animation by manipulation of the manipulation buttons 24 (step S3), and then selects the number of persons output on the first and second monitors 21 and 26 (step S4).

Then, the first controller 30 operates the camera 22 to capture an image of the face of the user standing in the light screen 60. The camera 22 photographs the face of the user who makes facial expression as requested on the first and second monitors 21 and 26. The camera 22 captures three to four images for one user to get various poses. When the camera 22 captures an image, the lighting 28 irradiates light. The lighting 28 irradiates light to the user under the control of the second controller 40, which is instructed by the first controller 30. The user face image P3 captured as mentioned above is stored in the face image DB 51 (step S5).

If the user is photographed as mentioned above, the first controller 30 renders the captured user face image P3 to conform to a corresponding face animation data P1 of the sample animation selected by the manipulation buttons 24 and previously stored in the face animation data DB 52 according to a predetermined program, thereby making a face animation P4. The face animation P4 is then composed with a face-removed animation P2 previously stored in the face-removed animation DB 53 to make a composed animation P5 (step S6).

That is to say, as shown in FIGS. 6 and 7, the first controller 30 executes a face rendering module Y1 according to a predetermined program so that a captured user face image P3 is rendered conforming to a corresponding face animation data P1 of the sample animation selected by the manipulation buttons 24 to make the face animation P4, and then executes an animation composing module Y2 to compose the face animation P4 with a corresponding face-removed animation P2 of a sample animation stored in the face-removed animation DB 53 and selected by the manipulation buttons 24, thereby making a composed animation P5.

The above composed animation P5 is recorded and stored in a CD, which is inserted into the CD recorder 23 by the user, upon an instruction through the first and second monitors 21 and 26 (step S7). The CD was discharged from the empty CD supplier 20a under the control of the second controller 40, which is instructed by the first controller 30 in the step S2 at which cash is inserted. The animation P5 recorded and stored in the CD is a MPEG moving picture that may be output for 3 to 4 minutes, according to MPEG1 standards with a picture size of 352×240, 30 frames per second (29.97 fps), 10 MB per one minute, 30˜40 MB per one song. While the animation P5 is being recorded and stored in the CD, the printer 29 outputs a cover sheet 29a to be adhered to a case of the CD out of the casing 10, and the animation P5 recorded and stored in the CD is partially output through the first and second monitors 21 and 26 with outputting its sound through the speaker 27 (step S8).

If the animation P5 is completely recorded and stored in the CD, the CD is discharged out for the user to carry, and the first and second monitors 21 and 26 output a message inquiring whether an additional copy is required. If the user wants an additional one, the above procedure is repeated, while, if the user does not want an additional copy, the monitors output an initial screen (step S9).

### APPLICABILITY TO THE INDUSTRY

As described above, the present invention allows automatic composition of animation contents and a body part image photographed from a user, so there is no need of an operator and a labor cost is reduced. In addition, expensive 3D rendering software and high-performance computer may not be used. Moreover, the present invention may be easily realized as a vending machine installed outdoors.

What is claimed is:

1. An animation composing vending machine, comprising:
a casing of a predetermined shape to stand on a ground;
at least first and second monitors installed to an upper portion of the casing to be opposite to each other so that a user who makes a photograph and other persons are capable of watching images and texts displayed thereon at the same time;
a camera installed in the casing at a position adjacent to the first monitor so as to capture an image of a user face;
at least one speaker installed to an outer wall of the casing to output sounds in relation to animations;
a peripheral device unit including a CD (Compact Disk) recorder installed in the casing to record a composed animation of the user face image captured by the camera on a CD, manipulation buttons installed to the casing for the user to manipulate for selection according to a request from the first monitor, and a cash verification unit installed in the casing to verify insertion of cash;
a first controller installed in the casing in connection with the monitors, the camera, the speaker and the peripheral device unit,
wherein the first controller instructs the first monitor to output a demo animation stored in a DB (database) unit together with messages for guiding insertion of cash,
wherein, in case that cash is inserted into the cash verification unit, the first controller instructs the first monitor to output a plurality of sample animations stored in the DB unit and classified depending on theme and also guide the user to select the number of persons to be photographed,
wherein, in case that a specific sample animation and the number of persons to be photographed are selected by means of the manipulation buttons, the first controller instructs the camera to capture an image of a user face, renders the captured user face image to conform to a corresponding face animation data of the sample animation stored in the DB unit and selected by the manipulation buttons according to a predetermined program to make a face animation, composes the face animation with a face-removed animation of the corresponding sample animation stored in the DB unit to make a composed animation, and then transmits the composed animation to the CD recorder to be recorded and stored in a CD;
a second controller installed in the casing to be positioned between the first controller and the cash verification unit so as to control the cash verification unit; and
a DB unit having a plurality of databases in the casing in connection with the first controller so as to store the user face image captured by the camera, to store face animation data classified depending on theme, to store face-removed animations classified depending on theme, and to store demo animations, various messages and sample animations classified depending on theme, which are to be displayed on the first monitor.

2. The animation composing vending machine according to claim 1,
wherein the face animation data and the face-removed animation are data respectively obtained by data processing of 3D animation.

3. The animation composing vending machine according to claim 1, further comprising:
at least one lighting installed in the casing in connection to the second controller so as to irradiate light to the user photographed by the camera.

4. The animation composing vending machine according to claim 1, further comprising:
a printer installed in the casing in connection to the first controller so as to print a cover sheet to be adhered to the CD.

5. The animation composing vending machine according to claim 1, further comprising:
a light screen installed to the casing to be positioned in front of the first monitor.

6. The animation composing vending machine according to claim 1, further comprising:
an empty CD supplier installed in the casing in connection to the second controller so as to supply an empty CD.
